(19) United States
(12) Patent Application Publication
(10) Pub. No.: US 2016/0006146 A1
(43) Pub. Date: Jan. 7, 2016

(54) STRANDED ELECTRICAL CONDUCTOR COMPRISING A CIRCULAR PLUG-TYPE CONTACT JACK

(71) Applicant: AMPHENOL-TUCHEL ELECTRONICS GMBH, Heibronn (DE)

(72) Inventors: Alexander SCHRECK, Heilbronn (DE); Martin DORR, Leingarten (DE); Aki KUHMANN, Eppingen-Rohrbach (DE)

(21) Appl. No.: 14/768,892

(22) PCT Filed: Mar. 12, 2014
(86) PCT No.: PCT/DE2014/100085

§ 371 Date: Aug. 19, 2015

(30) Foreign Application Priority Data
Mar. 19, 2013 (DE) 10 2013 004 708.0

(51) Int. Cl. H01R 11/12; H01R 11/28; H01R 4/02

(52) U.S. Cl. CPC H01R 11/12; H01R 4/023; H01R 11/28

(57) ABSTRACT

The invention relates to a striuidcd electrical conductor consisting of copper for making contact, in parallel and/or in series, with circular plug-type contacts having a line cross section, wherein at least one section of the stranded conductor has a section with a compressed, reduced cross section, and a cylindrical circular plug-type contact jack or a cylindrical circular plug-type contact pin is welded to this section.

The present invention relates to a stranded electrical conductor according to claim 1.

The present invention therefore relates, in particular, to a stranded electrical conductor composed of copper for making contact in parallel and/or in series with circular plug-type contacts, which stranded electrical conductor has a circular plug-type contact pin or a circular plug-type contact jack.

The present invention can be used particularly well in the field of energy storage elements and hybrid drives or in the connection of applications with drive units or energy storage units.

Such energy stores are used, for example, in motor vehicles, in particular in motor vehicles with electric or hybrid drives.

Drives or energy stores usually consist of a plurality of cells which are to be electrically connected to one another. In particular for hybrid vehicles, many cells must be brought into contact with one another both in parallel (to increase the capacitance) and in series (to increase the voltage).

In the case of the required compact design of the energy stores, significant temperature fluctuations occur during operation of the energy store, particularly in view of the fact that, in the case of vehicles, the ambient temperature is likewise subjected to significant fluctuations.

In other applications, too, in which a flexible connection which is particularly releasable is necessary between a first and a second electrical component via which particularly high currents are to be transferred and which is furthermore subject to certain manufacturing tolerances, there is also a requirement to be able to flexibly connect a high-current contact element, in particular a circular plug-type contact.

Furthermore, there exists the technical problem that, owing to high currents, sizeable conductor cross sections must be provided.

Another technical problem is the vibrations and jolts occurring in the applications, which must be reliably absorbed.

Generically designed electrical conductors are disclosed, for example, in US 2006/0160422 A1, U.S. Pat. No. 4,934,958 A, U.S. Pat. No. 5,154,646 A and in DE 10 2006 047 926 A1.

The connection used in the prior art is generally realized using a rigid copper bar to which rigid and movable components are applied in a complex manner by means of various joints and connection methods.

Another considerable problem in the prior art is the use of copper as connecting material, since copper can be connected by soldering only with difficulty or not reliably, as is required in the automotive industry.

If, for example, the releasable plug-type contacts are manufactured from a first material which is different from copper or an alloy in which copper is only present in reduced amounts, a particular problem consists in connecting the plug-type contacts to the copper conductor.

In the prior art, therefore, crimp connections are primarily used to reliably produce the connection.

The present invention is therefore based on the problem of providing a stranded electrical conductor which is designed in a flexible and pluggable manner and already has a plug-type contact, in particular a circular plug-type contact, connected to the stranded conductor.

Further problems addressed by the present invention consist in reducing the number of components and hence reducing the susceptibility to faults.

Said problem is solved by a stranded conductor having the features of claim 1.

Advantageous developments of the invention are specified in the dependent claims.

All combinations of at least two of the features specified in the description, the claims and/or the figures also fall within the scope of the invention.

When value ranges are indicated, values which lie within said limits should also count as being disclosed as limit values and be able to be claimed in any desired combination.

The invention is based on the concept of providing a flexible stranded conductor, preferably of copper, which has a section which has been compacted and hence has been compressed into a shape such that the flexible stranded conductor has at least one section which is directly soldered to a circular plug-type contact.

In this way, it is possible for a flexible stranded conductor to resist the tolerances caused by assembly and to be used flexibly, wherein it has a solid section which can be combined and soldered even to other materials of circular plug-type contacts in a suitably treated manner owing to a surface treatment.

In this way, a multiplicity of variants is obtained with simultaneous reduction in the components since the sections at which the stranded electrical conductor has been sealed can be applied in a central or end region of the stranded conductor.

Therefore, according to the invention, a stranded electrical conductor is provided, which is composed of copper for making contact in parallel and/or series with circular plug-type contacts with a conductor cross section, wherein at least one section of the stranded conductor has a section which is compressed in cross section and has a reduced cross section and a cylindrical circular plug-type contact jack or a cylindrical circular plug-type contact pin is soldered to said section.

In a particularly advantageous embodiment of the invention, the section has been compressed by compaction.

In another advantageous embodiment, the compaction is performed using an ultrasound oscillation or by means of ultrasound, in which the wavelength has been matched to the material to be compacted.

It is therefore preferable for the compacted section to be compressed by means of ultrasound compacting.

In another advantageous configuration of the invention, the compressed section has a rectangular cross section.

In this way, a defined contact face can be provided on one side for the circular plug-type contact jack or the circular plug-type contact pin, with the result that particularly secure soldering is ensured.

In particular, the compressed section with its rectangular cross section should be designed such that a substantially even contact face is formed, with which the end face of the circular plug-type contact can make contact and be soldered.

Advantageously, in the region of the compressed end of the stranded electrical conductor, the latter has a surface which can be soldered, in particular a surface coating, which consists of a material which can be soldered to the material of the circular plug-type contact. This can be done by plating, application or coating with an appropriate surface coating material.

Alternatively, the surface may also be designed as a copper surface in the case of suitable material selection.

It is also advantageous if the circular plug-type contact jack or the circular plug-type contact pin is soldered with its cylinder end face directly onto the section. In this way, compact designs can be realized, in which a contact jack or contact pin arranged at a 90°-angle to the stranded conductor is provided.

In an alternative embodiment, a corresponding adaptor can also be soldered to the compressed section, with which adaptor a corresponding contact jack can also be arranged or soldered at a 180° angle or another angle.

In order to provide a particularly flexible connection arrangement, a stranded conductor composed of strands which are interwoven or woven together is provided.

In this case, a wide variety of weave patterns can be used in order to adapt the stranded conductor to the measure of flexibility and deformability appropriate to the application.

It is also advantageous if the stranded conductor has a substantially rectangular cross section and the compressed section is compressed in thickness and/or in width.

It is particularly advantageous if the compressed section is arranged at at least one end or at both ends of the stranded conductor. In this way, patch cables or connection cables can be provided.

Provided that a compressed section with a contact is also arranged in a central section, sub-distributors can in this way be directly arranged at the same stranded electrical conductor without requiring further components.

It is preferable to design the circular plug-type contact jack with a hyperbolic contact cage. By designing the circular plug-type contact jack with a hyperbolic contact cage, particularly high currents can be transferred, as a result of which a high-current connection can be realized with the appropriate stranded-conductor cross section.

In another advantageous configuration of the invention, the stranded conductor is compressed at one end by means of compaction such that a plug section which is rectangular in cross section is formed, which plug section can be directly plugged into a corresponding contact jack. In this way, it is also possible to realize plug-type solutions in order to plug the stranded conductor at one end into a correspondingly shaped application in which a jack contact is formed with corresponding rectangular cross section (cuboid design).

In another advantageous embodiment, an aperture can be formed in the compacted section, as a result of which an additional or alternative screw connection can be formed.

By selective arrangement or combination of the solutions mentioned above, a multiplicity of connection solutions can be provided, which consist merely of two components and, more precisely, of the flexible stranded electrical conductor and one or more plug-type contacts which are soldered to the stranded conductor.

Further advantages, features and details of the invention emerge from the description, preferred exemplary embodiments and on the basis of the drawing, in which

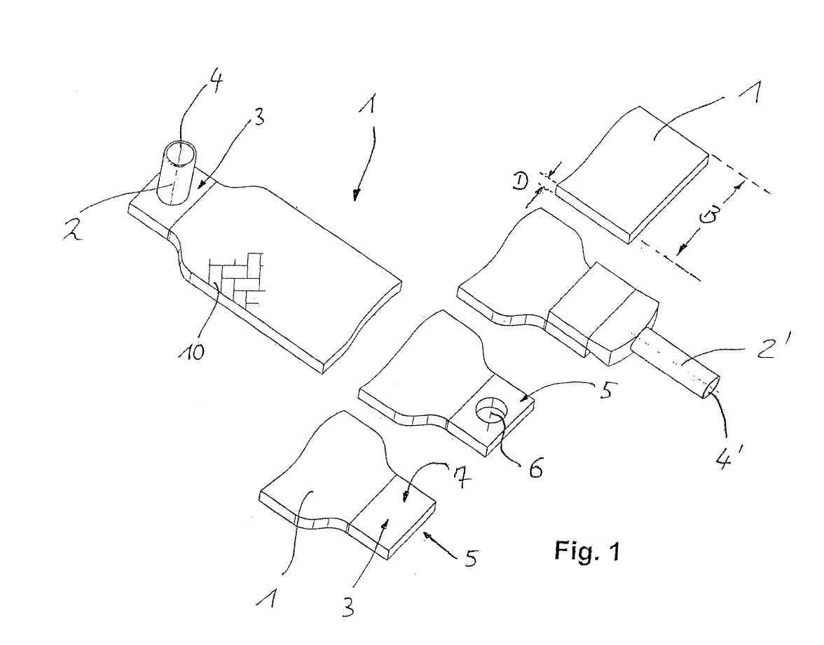

FIG. 1 shows a perspective view of a stranded electrical conductor according to the invention.

FIG. 1 shows a stranded conductor of copper and, more particularly, a stranded conductor 1 woven from copper strands 10. The stranded conductor 1 is designed as a substantially flat stranded conductor with a rectangular cross section A.

In the figure, the stranded conductor 1 is illustrated in a “separated” view for the sake of clarity, wherein different variants of one end are illustrated in the perspective view.

The four different shapes of the stranded conductor end are described in the following text from bottom to top.

The bottommost view illustrates an embodiment in which the stranded conductor 1 has a section 3 which has been reduced in cross section from the cross section A to the cross section A′ and, more particularly, compressed by compaction.

The segment 3 thus formed is designed as a substantially cuboid section and is pluggable with a corresponding mating plug (which is not illustrated).

As can be seen, the stranded conductor runs in a wider embodiment in the central section. As a result of the compaction, the width and the thickness have been reduced such that a substantially even and flat surface 7 is formed to which a circular plug-type contact 2, 2′ can be soldered.

At the upper left end, which is lying opposite in FIG. 1, of the stranded electrical conductor 1, a circular plug-type contact jack 2 is soldered with its end that points downward, more precisely the cylinder end face 4, on the surface 7 of the section 3.

This section 3 has also been compressed by compaction and thus forms a section which can be soldered of the otherwise woven stranded conductor surface.

In an alternative embodiment, the section 3, as described above, is designed with an aperture 6, in particular a circular aperture 6.

Further alternatively, a correspondingly designed circular plug-type contact pin can be soldered to a soldering section on the section 3, wherein the soldering section preferably has a corresponding flat soldering lower surface with which said region is soldered on the surface 7 of the section 3.

The upper right view is a general end shape of a compacted stranded conductor, more precisely in a rectangular embodiment.

The variants shown in FIG. 1 can also be combined with one another or extended as desired.

### LIST OF REFERENCE SIGNS

Stranded electrical conductor comprising a circular plug-type contact jack

1 stranded conductor

2 circular plug-type contact jack

2′ circular plug-type contact pin

3 compressed section

4 cylinder end face

4′ cylinder end face

5 plug section

6 aperture

7 surface

10 strand

A cross section

A′ cross section

B width

D thickness

1. A stranded electrical conductor composed of copper for making contact in parallel and/or in series with circular plug-type contacts with a conductor cross section (A), wherein at least one section of the stranded conductor has a section which is compressed in cross section and has a reduced cross section (A′) and a cylindrical circular plug-type contact jack or a cylindrical circular plug-type contact pin is soldered to said section.

2. The stranded electrical conductor as claimed in claim 1, characterized in that the compressed section has been compressed by compaction.

3. The stranded electrical conductor as claimed in claim 1, characterized in that the compressed section has a rectangular cross section.

4. The stranded electrical conductor as claimed in claim 1, characterized in that the compressed section has a surface which can be soldered, in particular a surface coating, which consists of a material which can be soldered to the material of the circular plug-type contact (2, 2′).

5. The stranded electrical conductor as claimed in claim 1, characterized in that the circular plug-type contact jack or circular plug-type contact pin is soldered with its cylinder end face onto the section.

6. The stranded electrical conductor as claimed in claim 1, characterized in that the stranded conductor has been formed from strands which are woven together.

7. The stranded electrical conductor as claimed in claim 1, characterized in that the stranded conductor has a substantially rectangular cross section and the compressed section is compressed in thickness (D) and/or in width (B).

8. The stranded electrical conductor as claimed in claim 1, characterized in that a compressed section is arranged at at least one end of the stranded conductor (1).

9. The stranded electrical conductor as claimed in claim 1, characterized in that the circular plug-type contact jack has a hyperbolic contact cage in the interior thereof.

10. The stranded electrical conductor as claimed in claim 1, characterized in that a plug section, which is compressed by compaction and is rectangular in cross section, is formed at one end of the stranded conductor.

11. The stranded electrical conductor as claimed in claim 10, characterized in that an aperture is formed in the plug section.
